(19) United States
(12) Patent Application Publication
(10) Pub. No.: US 2013/0296024 A1
(43) Pub. Date: Nov. 7, 2013

(54) Administering Wagering Games Having Supplemental Pot

(71) Applicant: SHFL ENTERTAINMENT, INC., Las Vegas, NV (US)

(72) Inventor: Louis J. Castle, II, Las Vegas, NV (US)

(73) Assignee: SHFL entertainment, Inc., Las Vegas, NV (US)

(21) Appl. No.: 13/864,069

(22) Filed: Apr. 16, 2013

Related U.S. Application Data
(60) Provisional application No. 61/642,043, filed on May 3, 2012.

(51) Int. Cl. G07F 17/32

(52) U.S. Cl. CPC G07F 17/32
USPC 463/25

(57) ABSTRACT

Methods and systems for administering wagering games are disclosed. A sample method comprises accepting a first mandatory wager from a player, the first wager is added to a first pot. A second wager, which may be mandatory or optional, is accepted from the player, the second wager is added to a second pot. A rake is taken from at least one wager. Cards are dealt to each player. The first wager is resolved according to a set of game rules, wherein a player wins at least a portion of the first pot at the conclusion of each round of play. The second wager is resolved by awarding a portion of the second pot or the entire second pot to at least one player who holds a predetermined winning hand combination or a premium winning hand composition.

### CROSS-REFERENCE TO RELATED APPLICATION

This application claims to the benefit of U.S. Provisional Patent Application Ser. No. 61/642,043, filed May 3, 2012, the disclosure of which is hereby incorporated in its entirety by this reference.

### FIELD

The disclosure relates generally to wagering games, and methods and systems of administering wagering games conducted live and online. More specifically, the disclosed embodiments relate to methods and systems of administering wagering games including at least one supplemental pot.

### BACKGROUND

Many casino wagering games have an inherent house advantage, even assuming perfect strategic play by a player. Thus, the house can ensure that the games are profitable over the long run, even when played by expert players. Suboptimal play by the players may cause additional profits, above a theoretical house advantage (i.e., the percent of wagers the house is expected to retain assuming that players and dealers engage in optimal strategic play and cheating does not occur), to be transferred from the players to the house.

Attempts have been made to modify games of the type described above. For example, U.S. Patent Application Pub. No. 2004/0023712 published Feb. 5, 2004, to Oliver discloses live casino games involving a mandatory jackpot wager and a mandatory underlying game wager. The house takes an up-front share of a progressive jackpot awarded according to a pay schedule, and the house advantage for the underlying game wager is zero or negative for optimal or near optimal play. As another example, U.S. Pat. Reissue No. 35,864 issued Jul. 28, 1998, to Weingardt discloses electronic video casino games in which the players are competing against each other to win from a common pool and are not wagering against the house. The house retains a rake. The awards to the players include pari-mutuel progressive jackpot payouts. As yet another example, U.S. Patent Application Pub. No. 2007/0111786 published May 17, 2007, to Snow discloses casino wagering games comprising an underlying casino wagering event, such as a card game, slot machine, dice game, etc., and a side wager that enters the player in a progressive jackpot event and a non-progressive bonus event.

### BRIEF SUMMARY

Embodiments of the present disclosure include a methods and systems of administering a wagering game. A sample method includes accepting a first wager from a player, the first wager being added to a first pot and accepting a second wager from the player, the second wager being added to a second pot. The method also includes taking a rake for a rake account from the second wager and dealing cards to each player. The first wager is resolved according to a set of game rules wherein a player wins at least a portion of the first pot at the conclusion of each round of play. The second wager is resolved according to at least one of: awarding a fixed odds payout to one or more players holding a predetermined winning hand combination from at least one of the rake account and the second pot, and awarding a progressive payout to one or more additional players holding a premium winning hand composition from the second pot.

Embodiments of the present disclosure also include a gaming system including one or more servers for administering a wagering game and one or more electronic devices configured for communication with the one or more servers. The one or more servers and the one or more electronic devices are configured to cooperatively execute the wagering game by performing the acts of accepting a first wager from a player, the first wager being added to a first pot, accepting a second wager from the player, the second wager being added to a second pot, taking a rake for a rake account from the second wager, and dealing cards to each player. The one or more servers and the one or more electronic devices are also configured to cooperatively resolve the first wager according to a set of game rules, wherein a winning player wins at least a portion of the first pot at the conclusion of each round of play. The one or more servers and the one or more electronic devices are also configured to cooperatively resolve the second wager according to at least one of: awarding a fixed odds payout to one or more players holding a predetermined winning hand combination from at least one of the rake account and the second pot, and awarding a progressive payout to one or more additional players holding a premium winning hand composition from the second pot.

Embodiments of the present disclosure also include a method of administering a wagering game online, using a combination of one or more servers in communication with one or more electronic devices for interfacing with game players. The method includes accepting a base game wager from one or more players for addition to a base pot, accepting a first supplemental wager from the one or more players for addition to a non-progressive pot, accepting a second supplemental wager from the one or more players for addition to a progressive pot, and taking a rake for a rake account from the second supplemental wager. A group of randomized cards are dealt to each of the one or more players from whom the base game wager has been accepted. The base pot is resolved according to a predetermined set of game rules. The non-progressive pot is resolved according to the predetermined set of game rules, wherein a payout of the non-progressive pot is credited to each player from whom a first supplemental pot wager has been accepted and who holds a highest ranking hand at the conclusion of a round of play according to the set of game rules. The progressive pot is resolved by crediting a payout to eligible players from whom the second supplemental pot wager has been accepted according to at least one of: odds payouts from the rake account or from the progressive pot to the eligible players holding one of a predetermined plurality of winning hand combinations, and an entire amount in the progressive pot to eligible players holding a premium winning hand combination.

### BRIEF DESCRIPTION OF THE DRAWINGS

FIG. 1A is a schematic block diagram of a gaming system for administering wagering games according to the present disclosure;

FIG. 1B is an alternate schematic block diagram of the gaming system of FIG. 1B;

FIG. 2 is a flow chart diagram of a method of administering a wagering game;

FIG. 3 is a block diagram illustrating various wagers, pots, and accounts used in various embodiments of the present disclosure;

FIG. 4 is an example of an single-player electronic gaming device configured for implementation of embodiments of wagering games according to the present disclosure;

FIG. 5 is an example of a suitable gaming table configured for implementation of embodiments of wagering games according to the present disclosure;

FIG. 6 is an example of a multi-player electronic gaming device configured for implementation of embodiments of wagering games according to the present disclosure;

FIG. 7 is a schematic block diagram of a gaming system configured for implementation of embodiments of wagering games according to the present disclosure; and

FIG. 8 is a block diagram of a computer system for acting as one or more components in a gaming system according to the present disclosure.

### DETAILED DESCRIPTION

The illustrations presented herein are not meant to be actual views of any particular gaming system, component thereof, or act in a method, but are merely idealized representations employed to describe illustrative embodiments. Additionally, elements common between figures may retain the same or similar numerical designation.

Disclosed embodiments relate generally to methods and systems of administering wagering games including a supplemental pot that may include at least one progressive pot. More specifically, disclosed are methods and systems of administering wagering games wherein the house takes a rake on the progressive pot.

Headings are included herein to aid in locating certain sections of detailed description. These headings should not be considered to limit the scope of the concepts described under any specific heading. Furthermore, concepts described in any specific heading are generally applicable in other sections throughout the entire specification.

The terms “gaming,” “gambling,” or the like, refer to activities, games, sessions, rounds, hands, rolls, operations, and other events related to wagering games such as web games, casino games, card games, dice games, and other games of chance for which wagers may be placed by a player. In addition, the word “wager,” “bet,” “bid” or the like, refer to any type of wagers, bets or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play-for-pay” as well as “play-for-fun,” as will be described in more detail below.

As used herein the terms “house” and “game administrator” mean one or more entities that, alone or in cooperation, provide one or more games to players (i.e., game participants) using a gaming environment, such as, for example, a single-player electronic gaming device, a multi-player electronic gaming device, a live gaming table, and various electronic gaming platforms that may be accessed by a player using a user device such as a computer, a portable computer, a portable communication device, a personal digital assistant and other suitable devices for communication with the electronic gaming platform.

As used herein, the term “theoretical house advantage” means the percent of wagers that the house is expected to retain assuming that players, and dealers where applicable, engage in optimal strategic play and cheating does not occur.

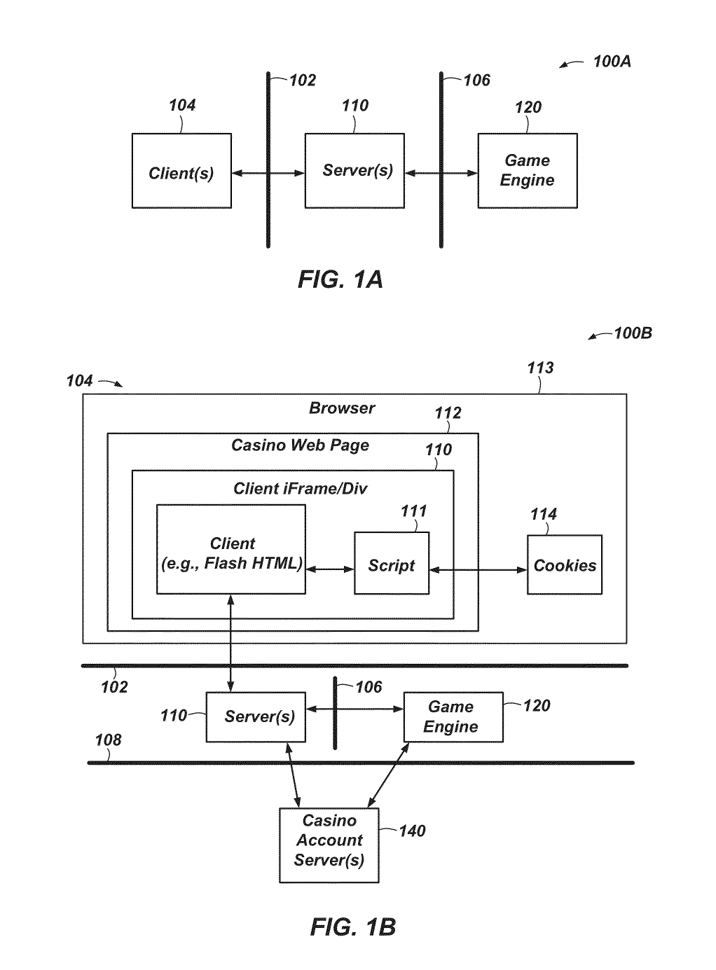

FIG. 1A is a schematic block diagram of a gaming system 100A suitable for implementation of embodiments of wagering games according to the present disclosure. The gaming system 100A may be an online gaming system that enables end users access to proprietary game content through one or more servers 110. For ease of description, the one or more servers 110 are generally referred to herein as a server 110. Such game content may include, without limitation, various types of wagering games such as card games, dice games, big wheel games, roulette, scratch off games, and any other wagering game that uses a fixed set of game pieces for a particular round or cycle of the game and randomly selects game pieces to determine the game outcome.

The gaming system 100A includes a gaming platform that establishes a portal for an end user using a device as a client 104 to access a wagering game hosted by a game engine 120 through the server 110. The client 104 may be configured to communicate with the server 104 through a firewall 102 over a network, such as a Wide Area Network (WAN), a Local Area Network (LAN), and the Internet. The server 110 may be configured to communicate with the game engine 120 through a firewall 106 over a network, such as a Wide Area Network (WAN), a Local Area Network (LAN), and the Internet.

In some embodiments, a single server 110 may be provided to communicate with the game engine 120, while other embodiments may include a plurality of servers 110 configured to communicate with a plurality of clients 104 to provide end users with access to the same game engine 120. In addition, a plurality of end users using a plurality of clients 104 may access a single server 110 or a plurality of servers 110 to access the game engine 120.

The game engine 120 may be configured to perform game play methods and determine game play outcomes that are provided to the server 110 to be displayed on the client 104. For example, the game engine 120 may include game rules for one or more wagering games, such that the game engine 120 may control the game flow for a selected wagering game, as well as the determining game outcomes, pay tables, etc. The game engine 120 may also perform random number generation for determining the random game pieces of for the wagering game.

The main processing of the gaming system 100A may occur in the game engine 120, the server 110, or a combination thereof. For example, the client 104 may be provided with a relatively small amount of script (e.g., JavaScript), also referred to as a “script driver,” including scripting language that controls the interfacing of the client 104 with the server 110. The script driver may include simple function calls requesting information from the server 110 and game engine 120. In other words, the script driver stored in the client 104 may merely include calls to functions that are externally defined by, and executed by, the game engine 120. As a result, the client 104 may be characterized as a “thin client.” As that term is used herein, the client 104 may be little more than a script player. The client 104 may simply send requests to the server 110 and game engine 120 rather than performing logic itself. The client 104 may receive player inputs, and such player inputs may be merely passed to game engine 120 for processing and executing the wagering game. As a result, the bulk of the processing of the game play is performed in the server 110, the game engine 120, or combination thereof. The server 110 may receive intermediate data and final game outcome information from the game engine 120 for displaying on the client 104 after such is determined by the game engine 120.

The game engine 120 may further host assets (e.g., audio files, video files, image files, etc.) that may be sent to the client 104 for presenting the various wagering games to the end user. In other words, the assets presented to the end user may be stored separately from the client 104, and the client 104 may request the assets running the script. For example, the client 104 may call an externally defined function, which may determine what assets are to be delivered to the client 104 as well as how the assets are to be presented to the end user. Different assets may correspond to the various clients 104 that may have access to the game engine 120.

The wagering games supported by the gaming system 100A may be operated as play-for-pay, play-for-fun, or both. For example, the play-for-pay option may include traditional casino and lottery-type wagering games in which money or other items of value are wagered and may be cashed out at the end of a game session. The play-for-fun option may include wagering games in which credits (or other symbols) may be issued to a player to be used for the wagers. For example, credits may be purchased by a player or issued through other methods. Although credits may be won or lost, the ability of the player to cash out the credits may be prevented. In other words, while the credits may be purchased, the credits in a play-for-fun option may be limited to non-monetary credits in terms of the ability of the player to extract cash or goods or services of monetary value out of the wagering game. Examples of systems that operate play-for-fun games may include issuance of free credits. In some embodiments, a limited number free credits may be issued in order to entice players to play the games. Credits may be won or lost, but credit balances may not be cashed out. In exchange for identifying friends who may want to play, the system may issue additional credits. Often, additional credits may be issued after a period of time has elapsed to encourage the player to resume playing the game. The system may enable players to buy friends or additional game credits to allow the player to resume play-for-fun play. However, neither credits earned nor credits remaining may be cashed in exchange for something of monetary value. It is contemplated that objects of value may be awarded to play-for-fun players, but not in a direct exchange for credits. For example, the client may award a prize for a highest scoring play-for-fun player during a defined time interval. Enabling players to buy fake friends, extra credits, and/or game pieces that allow the player to advance through the game levels with more speed may provide an additional source of revenue to the administrator of the gaming system 100A.

FIG. 1B is a schematic block diagram of a gaming system 100B suitable for implementation of embodiments of wagering games according to the present disclosure. The gaming system 100B includes the client 104, the server 110 and the game engine 120 as discussed above with respect to FIG. 1A to provide gaming content and enable secure online gaming. Also as discussed above, the server 110 may include the code supporting the client 104 as well as scripts 111 on the client 104. The client 104 may interface with an end user through a web page, an application (e.g., a smartphone or tablet application), or other computer program in order to access the gaming system 100B. As shown in FIG. 1B, the client 104 is illustrated within a casino webpage 112 (or other interface) indicating that the client may be embedded into a webpage, which may be supported by a web browser 113. The web browser 113 may communicate with the server 110, such as through sending cookies 114 associated with the use of the gaming system 100B and the webpage 112 to be stored by the client 104.

The server 110 may be operated by a third party, such as a casino, that links to the game engine 120. Therefore, in some embodiments, the server 110 may be operated by a different administrator than the operator of the game engine 120. In other words, the server 110 may be part of a third-party system that does not administer the game engine 120. For example, a gaming entity (e.g., a casino) may operate the server 110 to provide its customers access to game content managed by a different entity. It is also contemplated that in some embodiments, the server 110 may be operated by the same administrator as the game engine 120. For example, a gaming entity (e.g., a casino) may elect to perform each of these functions in-house, such as providing both the access to the server 110 and the actual game content and providing administration of the game engine 120 as well.

The game engine 120, the server 110, or both may also communicate with external casino account servers 140 through another firewall 108. For example, the game engine 120 itself may not take wagers or issue payouts. In other words, the game engine 120 may facilitate online casino gaming, but may not be part of a self-contained online casino itself. Instead, the game engine 120 may facilitate the play of proprietary card game content owned and controlled by a company offering games and gaming products and services, such as SHFL Entertainment, Inc. Another entity (e.g., a casino) may operate and maintain its external account servers 140 to take bets and make payout distributions. The game engine 120 (e.g., through internal account servers—not shown) may communicate with the external account servers 140 to verify the existence of funds for wagering, and instructs the external account servers 140 to execute debits and credits.

In some embodiments, the gaming system 100B may take bets and make payout distributions, such as in the case where administrator of the gaming system 100B operates as a casino. As discussed above, the gaming system 100B may be integrated within the operations of a casino rather than separating out functionality (e.g., game content, game play, credits, debits, etc.) among different entities. In addition, for “play-for-fun” wagering games, the gaming system 100B may issue credits, take bets, manage the balance of the credits according to the game outcomes, but may not permit payout distributions or be linked to play-for-fun servers 110 that do not permit payout distributions. Such credits may be issued for free, through purchase, or for other reasons, without the ability for the player to cash out. Such play-for-fun wagering games may be played on platforms that do not permit traditional gambling, such as to comply with jurisdictions that do not permit online gambling.

The gaming systems 100A and 100B of FIGS. 1A and 1B may each be configured according to a distributed server architecture. For example, the game engine 120 may be include a plurality of servers (e.g., game rules server, deck server, game routing server, account server, asset server, etc.) that are logically separated to perform different functions for the wagering game. In addition, the server 110 and the game engine 120 may be combined into a single server. Additional features may be supported by the game engine 120, such as hacking and cheating detection, data storage and archival, metrics generation, messages generation, output formatting for different end user devices, as well as other features and operations. For example, the gaming systems 100A and 100B may include additional features and configurations as described in U.S. patent application Ser. No. 13/353,194, filed Jan. 18, 2012, and titled “Network Gaming Architecture, Gaming Systems, and Related Methods,” the disclosure of which is incorporated hereby in its entirety by reference.

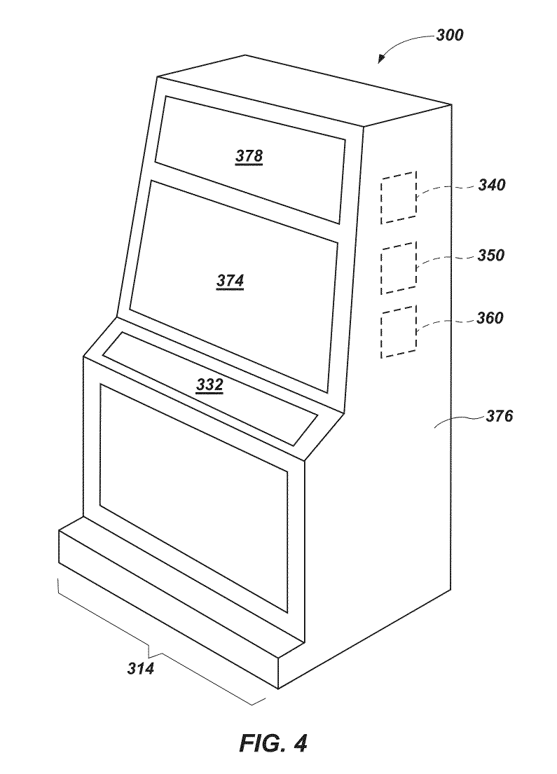

In addition, more details on live gaming tables and electronic gaming environments for practicing embodiments of the present disclosure are discussed below with reference to FIGS. 4-8.

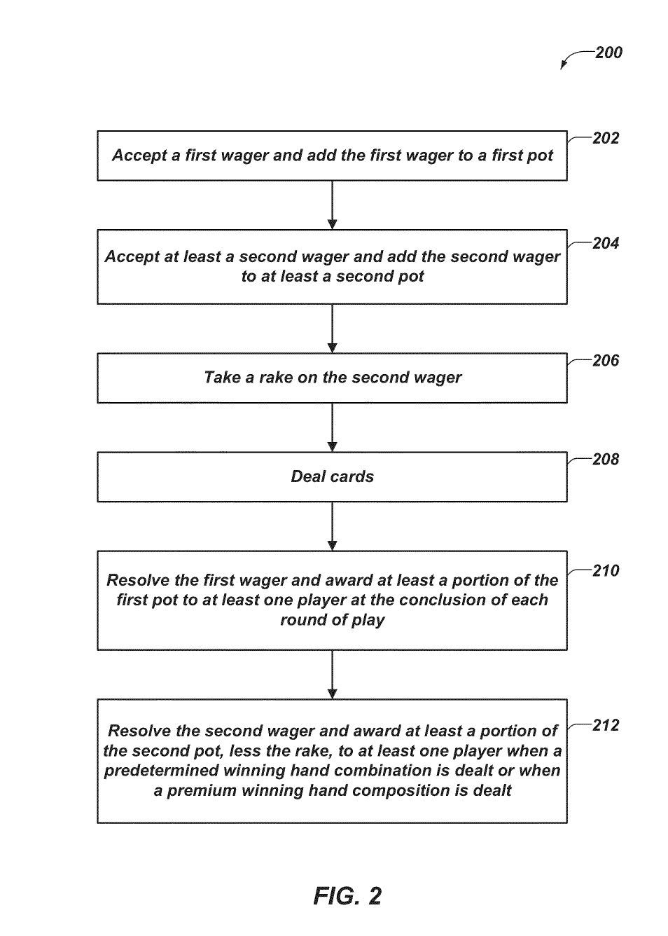

FIG. 2 is a flow chart diagram of a method of administering a wagering game.

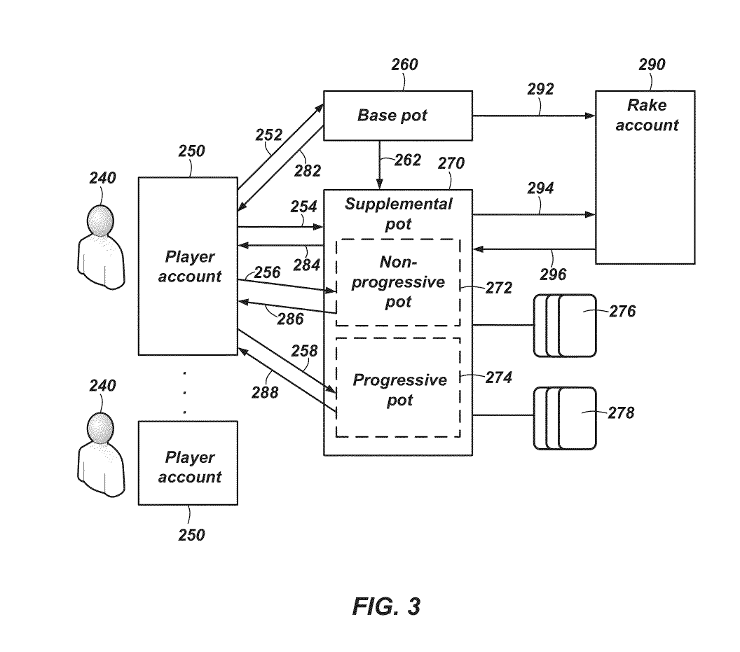

FIG. 3 is a block diagram illustrating various wagers, pots and accounts used in various embodiments of the present disclosure.

Referring to FIGS. 2 and 3, the method 200 includes accepting a first wager 252 from a player 240 and adding the first wager 252 to a first pot 260 (e.g., a pool or accumulation of bets), as indicated at operation 202. The first pot 260 may also be referred to herein as a base pot 260. The first wager 252 may comprise, for example, a base game wager 252. Such a base game wager 252 may include, for example, antes, blinds, play bets, raises, and other bets made on the underlying wagering game. The base game wager 252 may be accepted and the wagering game may be played only against other players 240 in the wagering game, not against the house, in some embodiments. In other embodiments, the base game wager 252 may be accepted and the wagering game may be played against the house. The wagering game may comprise, for example, poker or a variant of poker (e.g., five-card poker, THREE CARD POKER®, Mississippi Stud, TEXAS HOLD 'EM™, and Caribbean Stud).

The first wager 252 may be accepted by, for example, electronically accepting funds from a player account 250 or other credit authorized via one or more communications media (e.g., via the Internet, wireless communications, land line) on a remote electronic device (e.g., a personal computer, a laptop, a tablet computer, or a smartphone) by player input, electronically accepting funds from a player account authorized on a local wagering game administration device in a casino by player input, or physically placing monies or representations of monies (e.g., chips) on a table at a live game in a casino. Suitable network architecture for electronically accepting funds from a player account 250 authorized on a remote device may comprise, for example, the network gaming architecture disclosed in U.S. patent application Ser. No. 13/353,194 filed Jan. 18, 2012, to Costello et al., and suitable local wagering game administration devices may comprise, for example, the chipless tables disclosed in U.S. Patent Application Pub. No. 2010/0016050 published Jan. 21, 2010, to Snow et al., the disclosure of each is incorporated hereby in its entirety by reference

At least a second wager 254 may be accepted and added to at least a second pot 270, as indicated at operation 204. The second pot 270 and the second wager 254 may also be referred to herein as a supplemental pot 270 and a supplemental wager 254, respectively. The second pot 270 may be separate from the first pot 260. For example, the first and second pots (260 and 270) may include chips located in separate areas on a gaming table when the wagering game is conducted live in a casino. As another example, the first and second pots (260 and 270) may be displayed as separate amounts on a video display (e.g., a monitor) controlled by a client 104 and may be maintained in separate accounts when the wagering game is conducted online.

The second wager 254 may enable the player 240 to be eligible to win an additional award, such as, for example, a progressive payout 288 (e.g., a progressive jackpot), from the second pot 270. The second wager 254 may be accepted and the wagering game may be played only against other players 240 in the wagering game, not against the house, in some embodiments. In other embodiments, the second wager 254 may be accepted and the wagering game may be played against a pay table defined by the house.

In some embodiments, the second wager 254 may be a mandatory wager. In such embodiments, a player 240 must place both the first wager 252 and the second wager 254 to play the wagering game.

In other embodiments, the second wager 254 may be optional, and a player wishing to play the wagering game may do so without placing the second wager 254 and without being eligible to win any award from the second pot 270.

In some embodiments, the second wager 254 may include multiple sub-wagers. For example, the second wager 254 may include a first supplemental wager 256 for a non-progressive pot 272, and a second supplemental wager 258 for a progressive pot 274. Such pots may be considered as separate from one another, but within the second pot 270, and separate from the first pot 260.

The second wager 254 may be accepted by, for example, electronically accepting funds from the player account 250 authorized on a remote electronic device by player input, electronically accepting funds from a player account 250 authorized on a local wagering game administration device in a casino by player input, or physically placing monies or representations of monies on a table at a live game in a casino.

In some embodiments, the second pot 270 may be a pooled pot. For example, the second pot 270 may include second wagers 254 accepted from multiple concurrent wagering games, which may include only second wagers 254 from those wagering games currently being played or may include accumulated second wagers 254 from past wagering games. As specific, non-limiting examples, the second pot 270 may include all second wagers 254 accepted from a group of tables or local wagering game administration devices at a casino, from multiple groups of remote devices connected to network gaming architecture, or both.

In other embodiments, the second pot 270 may not be pooled, and awards for the second wager 254 may be limited to the amounts wagered at a respective table, local wagering game administration device, or group of remote devices.

A rake 294 (e.g., a commission for the house) may be taken on the second wager 254 and placed in a rake account 290, as indicated at operation 206. For example, the house may collect a portion of the second wager 254 at the time the second wager 254 is placed, or may collect a portion of amounts awarded from the second pot 270 at the time the second pot 270 or a portion of the second pot 270 is awarded. The rake 294 may comprise a fixed percentage of the second wager 254. For example, the percentage of the second wager 254 collected for the rake 294 may be greater than a theoretical house advantage for the underlying game.

As another example, the rake 294 may be less than an average house advantage for play of the wagering game by all players 240, including average and sub-average players. The average house advantage may be calculated using historical house advantage information for the wagering game (e.g., a house advantage for the wagering game over the last 5, 10, or 15 years for a given casino). As specific, nonlimiting examples, the percentage of the second wager 254 collected for the rake 294 may be between 3% and 8%, between 4% and 7%, or between 5% and 6%. In other embodiments, the portion of the second wager 254 collected for the rake 294 may comprise a variable percentage of the second wager 254 or may comprise a fixed quantity (e.g., a flat fee) irrespective of the total amount for the second wager 254, a fixed percentage with a cap, or a time-based fee for increments of time playing the wagering game.

All profits for the house may be made from the rake account 290 in some embodiments. In such embodiments, all second wagers 254 in excess of the rake 294 may be redistributed back to the players 240, rather than be collected by the house as additional revenue. Such limiting of profits for the house and redistribution of second wagers 254 back to the players 240 may increase the attractiveness of the wagering game to both inexperienced and highly skilled players 240. Because the amount earned by the house is known, highly skilled players may perceive that their skill will enable them to increase winnings, and inexperienced players may be enticed by the possibility of winning the second pot 270 or a portion thereof.

In other embodiments, the house may make profits on the rake 294 and on losses from the second wagers 254, including losses resulting from optimal and suboptimal play.

The rake 294 may be maintained in the rake account 290, and profits for the house may be deducted (not shown) from the rake account 290. The rake 294 may be taken by, for example, electronically transferring funds from the second pot 270 to the rake account 290 (e.g., as instructed by a game engine 120 using casino account servers 140) or physically removing or exchanging monies or representations of monies from the second pot 270 on a live table.

Cards may be dealt to all participating players 240, as indicated at operation 208. The number and kinds of cards dealt to players 240 may depend on the wagering game being played. In embodiments where the wagering game is played at a live table or at a wagering game administration device in a casino, physical cards may be dealt to the players 240 or electronic representations of cards may be displayed to the players on a video display or on video displays of a respective wagering game administration device. In embodiments where the game is played remotely on a remote electronic device (e.g., on a player's personal computer, laptop, tablet computer, or smartphone), electronic representations of cards may be transmitted to the players 240 for display on their respective devices.

In some embodiments, the cards may be dealt in successive rounds with intermittent opportunities to increase wager amounts (e.g., during rounds of betting) in accordance with a set of game rules of the underlying wagering game being played. For example, the players 240 may have the opportunity to add to the amounts of their first wagers 252, which may increase the amount of the first pot 260 to be won. As another example, the players 240 may optionally add to the amounts of their second wagers 254, which may include multiple sub-wagers, to increase the amount of the second pot 270, which may include multiple sub-pots, although the amount of the second wager 254 may be fixed in some embodiments without the ability to add thereto. In other embodiments, the cards may be dealt in a single round with only one, or with no, opportunity to increase wager amounts.

After dealing the cards is complete and at the conclusion of any rounds of betting, the first wager 252 may be resolved and at least a portion of the first pot 260 may be awarded as a base award 282 to at least one player 240, as indicated at operation 210. Each successive round of making wagers, dealing cards, and resolving wagers may constitute a round of play, and the first pot 260 or a portion of the first pot 260 may be awarded to at least one player 240 at the end of each round of play. The player 240 to whom the first pot 260 or the portion of the first pot 260 is awarded may hold a winning hand or at least a tying hand for that round of play according to the rules of the wagering game being played. Awarding the first pot 260 or the portion of the first pot 260 may comprise crediting a player account 250 of each wining player 240 or may comprise distributing physical monies or physical representations of monies to each winning player.

In some embodiments, an entire amount of the first pot 260 may be awarded to at least one player at the end of each round of play. In such embodiments, the first pot 260 may be considered as non-progressive. The award of the entire first pot 260 to at least one player 240 at the end of each round of play may enable the wagering game to qualify as a legal form of online gambling under some relevant statutes. Awarding the entire amount of the first pot 260 to at least one player at the end of each round of play redistributes lost first wagers 252 attributable to suboptimal play to other players 240, rather than to the house. Accordingly, such a wagering game may be particularly attractive to players 240 who perceive themselves as being highly skilled in the wagering game and, therefore, more able to take advantage of suboptimal play by other players 240.

In other embodiments, a portion of the first pot 260 may be awarded to at least one player 240 at the end of each round of play. For example, the house may take an additional rake 292 on the first wager 252 in addition to the rake 294 taken on the second wager 254, which may still enable the wagering game to be qualify as a legal form of online gambling under some relevant statutes. The additional rake 292 taken on the first wager 252 may comprise, for example, between 1% and 8%, between 2% and 6%, or between 3% and 5% of the first wager 252, and may be less than the rake 294 taken on the second wager 254 in some embodiments. In other embodiments, the additional rake 292 may be taken from winnings from the first pot 260.

In still other embodiments, a portion of the first wager 252 may remain in the first pot 260 or be redistributed 262 to the second pot 270 to be awarded in a subsequent round of play as a progressive pot 274. In such an example, the portion of the first wager 252 remaining in the first pot 260 or redistributed 262 to the second pot 270 may comprise, for example, a fixed percentage of the first wager 252, a variable percentage of the first wager 252 (e.g., an odds payout may be awarded and the remainder retained in the first pot 260 or redistributed 262 to the second pot 270), or a fixed amount.

In lieu of or in addition to a rake (292, 294) taken on one or more wagers or from winnings, the house may be compensated in a number of other ways, including without limitation a flat fee per round of play, a percentage of wagers made with a cap, rental of a player “seat,” or otherwise as is known in the gaming art. All such compensation may be generally referred to as a commission.

As indicated at operation 212, the second wager 254 may be resolved and at least a portion of the second pot 270, less the rake 294 taken on the second wager 254, may be awarded as a supplemental award 284 to at least one player 240 when a predetermined winning hand combination 276 is dealt or when a premium winning hand composition 278 is dealt. The second pot 270 may not be awarded at the end of each round of play, but may grow during each successive round in which no player 240 is dealt a predetermined winning hand combination 276 or a premium winning hand composition 278. In other words, the second pot 270 may be a progressive pot 274, the award of which may depend on the cards held by the players 240.

Awarding the second pot 270 or the portion of the second pot 270 may comprise crediting a player account 250 with funds from the second pot 270 or may comprise distributing physical monies or physical representations of monies from the second pot 270 to the player 240. In some embodiments, all players 240 participating in the wagering game who have made the second wager 254 may be eligible to win the second pot 270 or a portion of the second pot 270, including players 240 who have folded or are otherwise ineligible to win the first pot 260.

A predetermined winning hand combination 276 may comprise, for example, four-of-a-kind, a full house, a flush, a straight, three-of-a-kind, two pair, or one pair. For example, a portion of the second pot 270 may be awarded to a player 240 holding a full house when a full house has been predetermined to be a winning hand combination. A hand or a set of hands qualifying as a new winning hand combination or a set of new winning hand combinations may be predetermined at the beginning of each round of play in some embodiments. In other embodiments, a new winning hand combination or a set of new winning hand combinations may be predetermined at the beginning of play and may remain fixed until at least one player 240 achieves the predetermined winning hand combination 276 or the premium winning hand compositions 278, at which time a new winning hand combination or a set of new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, or may be predetermined following a schedule of possible winning hand combinations. For example, a game engine 120 or a live dealer administering the wagering game may randomly predetermine from among, or may sequentially cycle through a table including, a group of possible winning hand combinations consisting of four-of-a-kind, a full house, a flush, a straight, three-of-a-kind, or two pair to predetermine the winning hand combination for a round or for multiple rounds of play.

In embodiments where a portion of the second pot 270 is awarded to at least one player 240 holding a predetermined winning hand combination 276, the portion may comprise a percentage of the second pot 270 corresponding to the odds of receiving that predetermined winning hand combination 276 (e.g., an odds payout), may comprise a fixed percentage of the second pot 270, or may comprise a fixed quantity (e.g., a fixed payout), which may also correspond to the odds of receiving that predetermined winning hand combination 276 (e.g., a fixed odds payout 286). For example, the portion of the second pot 270 awarded to at least one player 240 holding a predetermined winning hand combination 276 may be a first fixed amount for a full house, a second, lower fixed amount for a flush, or a third, lowest fixed amount for a straight, where the set of predetermined winning hand combinations 276 includes a full house, as straight, and a flush. As a specific, non-limiting example, a player 240 holding a predetermined winning hand combination 276 may be awarded 20% of the second pot 270. The second pot 270 may be decremented by the amount awarded to each player 240 holding a predetermined winning hand combination 276 in embodiments where a payout (e.g., a fixed odds payout 286) is taken from the second pot 270, not the rake account 290.

In some embodiments, the second pot 270 or a portion of the second pot 270 may be awarded to each player 240 holding the predetermined winning hand combination 276, rather than a single player 240. In such embodiments, each player 240 holding a predetermined winning hand combination 276 may be awarded an equal portion of the second pot 270 or may be awarded different portions of the second pot 270 (e.g., different quantities based on the odds of holding different predetermined winning hand combinations 276 or different quantities for holding differently ranked predetermined winning hand combination 276).

In other embodiments, the second pot 270 or a portion of the second pot 270 may be awarded to only one player 240 who holds the highest ranked predetermined winning hand combination 276, while other players 240 holding predetermined winning hand combinations 276 may not be awarded any portion of the second pot 270.

In still other embodiments, the second pot 270 or the portion of the second pot 270 may be awarded to only one player 240 who holds the highest ranked predetermined winning hand combination 276 and who holds the winning hand for the underlying game.

A premium winning hand composition 278 may comprise, for example, four-of-a-kind, a straight flush, or a royal flush. The hand compositions that will qualify as premium winning hand compositions 278 may be predetermined at the beginning of play. For example, at the outset of the wagering game, it may be predetermined that only straight flushes and royal flushes will qualify as premium winning hand compositions 278. The hand compositions qualifying as premium winning hand compositions 278 may remain fixed throughout the duration of the wagering game or may change during the wagering game. For example, after a player 240 has achieved a premium winning hand composition 278, the hand compositions qualifying as premium winning hand compositions 278 may be made more restrictive or less restrictive. As a specific, non-limiting example, after a player 240 has achieved a straight flush, the hand compositions qualifying as premium winning hand compositions 278 may be restricted to royal flushes or may be expanded to four-of-a-kind. The hands that will qualify as premium winning hand compositions 278 may be predetermined at random from a list of possible premium winning hand compositions 278, or may be predetermined following a schedule of possible premium winning hand compositions 278. For example, a game engine 120 or a live dealer administering the wagering game may randomly predetermine from among, or may sequentially expand and contract a table including, a group of possible premium winning hand compositions 278 consisting of four-of-a-kind, a straight flush, or a royal flush, which will be the predetermined premium winning hand composition 278 for a round or for multiple rounds of play.

The amount awarded from the second pot 270 for achieving a premium winning hand composition 278 may be a progressive payout 288 at least as great as a maximum award possible for achieving a predetermined winning hand combination 276. For example, the entire second pot 270 may be awarded when a player 240 or multiple players 240 are dealt a premium winning hand composition 278, and only a portion of the second pot 270 may be awarded when a player 240 or multiple players 240 are dealt a predetermined winning hand combination 276. In embodiments where a portion of the second pot 270 is awarded for premium winning hand compositions 278, the portion awarded may comprise a percentage of the second pot 270 corresponding to the odds of receiving that premium winning hand composition 278 (e.g., an odds payout), may comprise a fixed percentage of the second pot 270, or may comprise a fixed quantity (e.g., a fixed payout), which may also correspond to the odds of receiving that premium winning hand composition 278 (e.g., a fixed odds payout 286). In other embodiments, the entire amount of the second pot 270 may be awarded for premium winning hand compositions 278.

In some embodiments, the second pot 270 or a portion of the second pot 270 may be awarded to each player 240 holding a premium winning hand composition 278. In such embodiments, each player 240 holding a premium winning hand composition 278 may be awarded an equal portion of the second pot 270 or may be awarded different portions of the second pot 270 (e.g., different quantities based on the odds of holding different premium winning hand compositions 278 or different quantities for holding differently ranked premium winning hand compositions 278).

In other embodiments, the second pot 270 or a portion of the second pot 270 may be awarded to only one player 240 who holds the highest ranked premium winning hand composition 278, while other players 240 holding premium winning hand compositions 278 may not be awarded any portion of the pot.

In still other embodiments, the second pot 270 or the portion of the second pot 270 may be awarded to only one player 240 who holds the highest ranked premium winning hand composition 278 and who holds the winning hand for the underlying game.

When one player 240 holds a predetermined winning hand combination 276 and another player 240 holds a premium winning hand composition 278 at the conclusion of a single round of play, the second pot 270 may be awarded in its entirety to the player 240 holding the premium winning hand composition 278 in some embodiments. In other embodiments, each player 240 may be awarded a portion of the second pot 270, the amounts of which may include, for example, percentages of the second pot 270 corresponding to the relative odds of receiving that premium winning hand composition 278 and that predetermined winning hand combination 276. In still other embodiments, the player 240 holding the premium winning hand composition 278 may be awarded the entire amount of the second pot 270 and the player 240 holding the predetermined winning hand combination 276 may be awarded a fixed odds payout 286 deducted from the rake account 290.

In some embodiments, the second pot 270 may be seeded 296 with money from the rake account 290 at the beginning of play, after the second pot 270 or a portion of the second pot 270 has been awarded, or both. For example, the second pot 270 may be seeded 296 from the rake account 290 of the house, and the house may maintain an amount of funds in the rake account 290 sufficient to significantly reduce (e.g., to essentially eliminate) the likelihood that any payouts made from the rake account 290 and any seeding amounts withdrawn from the rake account 290 exhaust or overdraw the rake account 290. Such seeding may incentivize players 240 to participate in the wagering game, and specifically to place the second wager 254 to be eligible for the second pot 270. In addition, such seeding may reduce the likelihood that the amount of funds in the second pot 270 may be insufficient to cover all the payouts to players 240. For example, where a player 240 achieves a premium winning hand composition 278 in one round of play, a player 240 achieves a predetermined winning hand combination 276 in the immediately following round of play, and a fixed odds payout 286 is to be awarded to the player 240 holding the predetermined winning hand combination 276, the amount seeded 296 to the second pot 270 between those rounds of play may be at least as great as the maximum fixed odds payout 286 awardable for any predetermined winning hand combination 276. The second pot 270 may be seeded 296 each time the second pot 270 is awarded in its entirety or each time the amount in the second pot 270 is lower than the maximum fixed odds payout 286.

### 1. Example Games

Player-pooled THREE CARD POKER® is one specific, non-limiting, example of a wagering game according to embodiments of the present disclosure. The first wager 252 includes an ante and any play wagers in the first pot 260 to play against a dealer. The second wager 254 includes a wager in a second pot 270 against a pay table that the cards held by a player 240 at the end of a round of play will include a pair or a hand ranked higher than a pair (i.e., a pair plus wager). Each player 240 and the dealer are dealt three cards. Each player 240 elects to fold or make a play wager that is equal to the ante. The dealer's hand must qualify with a king high or better to play against the player's hand. Otherwise, the ante is a push. If the dealer's hand is a qualifying hand, a player 240 is paid 1:1 out of the first pot 260 if the player's hand beats the dealer's hand and the dealer collects all losing first wagers 252 from the first pot 260. A player 240 is paid odds out of the second pot 270 for holding a preselected winning hand combination of a pair to four-of-a-kind. This odds payout may include only a portion of the second pot 270. A player 240 wins 100% of the second pot 270 if the player 240 holds a premium winning hand composition 278 of a straight flush. Funds in the second pot 270 continue to grow from round to round until a player 240 achieves a straight flush. The house takes a rake (292 and 294) on all wagers that are won by the players 240, including the first, ante and play wagers 252 and the second, pair plus wager 254. After the second pot 270 is awarded, the house reseeds 296 the second pot 270 with funds from the rake account 290. Because both wagers have a house edge, the pair plus wager 254 is optional. In some embodiments, the house may require the player 240 to contribute to the second pot 270 over the entire jackpot cycle to qualify for a payout from the second pot 270. In other embodiments, players 240 can begin to contribute at any point in the jackpot cycle.

Player-pooled Mississippi Stud is another specific, non-limiting, example of a wagering game according to embodiments of the present disclosure. The first wager 252 comprises an ante and any play wagers in the first pot 260 to play against other players 240. The second wager 254 comprises a wager in a second pot 270 against the other players 240 that the cards held by a winning player at the end of a round of play will hold a pair of jacks or a hand ranked higher than a pair of jacks. The house collects a rake (292 and 294) comprising a flat fee, a percentage of wagers made, or a percentage of payouts made on all wagers. Three face-down community cards are dealt and each player 240 is dealt two cards. Players 240 view their respective cards and decide to fold or make a play wager to the first pot 260 that is between one and three times the amount of the ante. The first community card is revealed, and then the players 240 engage in another round of betting. The second community card is revealed, and the players 240 engage in a final round of betting. The third community card is revealed and the wagers are resolved. A player 240 must hold a pair of jacks or better to win the first pot 260, otherwise the first wager 252 is a push. Predetermined winning hand combinations 276 ranked higher than a pair of jacks but lower than a royal flush pay higher fixed odds payouts 286 from the second pot 270. The fixed odds payouts 286 may include only a portion of the second pot 270. A premium winning hand composition 286 of a five-card royal flush pays 100% of the amount in the second pot 270. The house reseeds 296 the second pot 270 using funds from the rake account 290 and covers fixed odds payouts 286 that exceed the amount in the second pot 270 in some embodiments. In other embodiments, the player 240 is paid what money is available and the next jackpot cycle is started. Because this game may be volatile, it may be desirable to use a higher seed amount and for the house to a collect a higher rake (292 and 294) to reduce the risk that the available funds from the second pot 270 will be insufficient to cover a payout.

Player-pooled ULTIMATE TEXAS HOLD 'EM® is another specific, non-limiting, example of a wagering game according to embodiments of the present disclosure. The first wager 252 comprises the blind wagers, antes, and any play wagers in the first pot 260 to play against other players 240. The second wager 254 comprises an optional “trips” bet against a pay table that one of the cards held by a player 240 will combine with two community cards to form three-of-a-kind. A rake 294 is taken on the second wager 254. Two cards are dealt to each player 240 and five community cards are dealt, face down. After viewing the dealt cards, each player 240 must check or bet three to four times the amount of the ante into the first pot 260. The three-card flop is revealed, and another round of betting into the first pot 260 ensues. The final two cards are revealed, and a final round of betting into the first pot 260 takes place. The player 240 holding the highest ranked five-card hand wins the first pot 260 or the players 240 holding the highest equally ranked five-card hands spilt the first pot 260 equally. A player 240 holding the highest ranked hand forming three-of-a-kind from one player's card and two community cards is awarded 100% of the second pot 270.

Caribbean Stud is another specific, non-limiting example, of a wagering game according to embodiments of the present disclosure. The first wager 252 comprises an ante and any play wagers to play against a dealer hand. The second wager 254 comprises a side bet that the player's hand will be four-of-a-kind or better. The house charges a flat fee or takes a percentage of wagers made or payouts awarded. Each player 240 and the dealer are dealt five cards, with one of the dealer's cards being dealt face up. The dealer views his hand, and makes a play wager of two times the amount of the ante if the dealer holds a qualifying hand of a king high or better, and the player 240 may match the play wager or fold. If the dealer hand does not qualify, the ante is paid 1:1 out of the first pot 260 and the play bet is returned to the player 240. The dealer reveals his other cards and resolves the hand. The player 240 and dealer hands are compared and when the player 240 holds a higher ranking hand than the qualifying dealer hand, the player 240 is paid 1:1 from the first pot 260. If the dealer hand ranks higher than the player hand, the first wager 252 in the first pot 260 from that player 240 is collected by the dealer, a rake 292 is taken on that first wager 252, and the remainder is distributed into the second pot 270. If the player 240 beats the dealer hand and has a predetermined winning hand combination 276 of four-of-a-kind or a straight flush, for example, the player 240 wins a portion of the second pot 270. If the player 240 holds a premium winning hand composition 278 of a royal flush, the player 240 is awarded 100% of the second pot 270. In some embodiments, all players 240 may split the second pot 270 equally if the dealer holds a predetermined winning hand combination 276 or a premium winning hand composition 278.

Player-pooled THREE CARD POKER® with a side bet is another specific, non-limiting, example of a wagering game according to embodiments of the present disclosure. The first wager 252 comprises an ante and any play wagers in a first pot 260 to play head-to-head against a dealer. The second wager 254 comprises an optional pair plus wager 254 in a second pot 270. Each player 240 and the dealer are dealt three cards. Players 240 view their respective hands and decide to fold or make a play bet to increase the first pot 260. If the player 240 folds, he forfeits the ante wager but remains eligible to win the pair plus bet 254 from the second pot 270. The dealer must qualify with a queen high to play against the player hand. The first wagers 252 pay 1:1 from the first pot 260 when the players' hands beat the dealer hand. Losing wagers from the first pot 260 are collected by the dealer, a rake 292 is taken, and the remainder is redistributed 262 into the second pot 270. A player 240 holding a predetermined winning hand combination 276 of a pair up to four-of-a-kind and who made the optional pair plus bet 254 is awarded a portion of the second pot 270. If a player 240 made the optional pair plus bet 254 and holds a straight flush premium winning hand composition 278, that player 240 is awarded the entire second pot 270.

Player-pooled side bets on a five-card poker game is another specific, non-limiting, example of a wagering game according to embodiments of the present disclosure. In this example, players 240 play conventional poker, such as no-limit Hold 'Em. Before each first round of betting first wagers 252 into a first pot 260 begins, players 240 make an optional second wager 254, for the second pot 270, on whether they will hold one of a set of predetermined winning hand combinations 276 or premium winning hand compositions 278. The house takes a rake 292 on either the amounts wagered, the odds payouts paid to the player 240, both the amounts wagered and won, the progressive payouts 288 or combinations thereof from the second pot 270. The first pot 260 is awarded to the player 240 holding the highest ranked hand at the end of each round of play. Odds payouts are made from the second pot 270 to players 240 holding predetermined winning hand combinations 276 of a straight flush to a pair of tens. For example, the odds payout schedule may comprise 200:1 for a straight flush, 50:1 for four-of-a-kind, 11:1 for a full house, 8:1 for a flush, 5:1 for a straight, 3:1 for three-of-a-kind, 2:1 for two pair or 1:1 for a pair of tens or better. A player 240 holding a royal flush as a premium winning hand composition 278 wins 100% of the second pot 270.

Player-pooled ULTIMATE TEXAS HOLD 'EM® with a mandatory side bet is another specific, non-limiting, example of a wagering game according to embodiments of the present disclosure. At least two players 240 make first wagers 252 comprising ante and any play wagers into a first pot 260 to play against one another. Each player 240 makes a mandatory second wager 254, for the second pot 270, that he or she will hold a predetermined winning hand combination 276 or a premium winning hand composition 278. The house takes a rake 294 on the second wager 254. Two cards are dealt to each player 240, five community cards are dealt face down, and rounds of betting to increase the first pot 260 take place as the community cards are revealed. The player 240 holding the highest ranked hand is awarded the entire first pot 260 in some embodiments. In other embodiments, the player 240 holding the highest ranked hand is awarded half of the first pot 260, and the other half is redistributed 262 into the second pot 270. If no player 240 holds a predetermined winning hand combination 276 or a premium winning hand composition 278, the second pot 270 remains to grow during the next round of play. Any player 240 holding a predetermined winning hand combination 276 is awarded a fixed odds payout taken from the rake account 290. A player 240 holding a highest-ranked premium winning hand composition 278 wins the entire second pot 270. The house may or may not provide seed money 296 into the second pot 270 from the rake account 290.

CRAZY 4 POKER® Progressive is another specific, non-limiting, example of a wagering game according to embodiments of the present disclosure. To begin, players 240 must make equal ante (i.e., first wager 252) for the first pot 260 and super bonus wagers 252 for the first pot 260. Players 240 and the dealer will each receive five cards to make their best four-card poker hand. After seeing their cards, players 240 may either fold or stay in the game by making another first wager 252, which must match their ante unless they have a pair of aces or better. If players 240 have at least a pair of aces, they may make another first wager 252 up to three times their ante. The dealer qualifies with a king-high or better. When players 240 beat the dealer's qualifying hand, their ante and play bets win even money from the first pot 260. When the dealer qualifies and beats a player's hand, the players' first bets lose. When the dealer does not qualify, the players' play bet wins and their ante bet pushes with winnings coming from the first pot 260. Super bonus wagers 252 and queens up wagers 252 are resolved normally from the first pot 260. An optional supplemental wager 254, into the second pot 270, wins if a player 240 has a three-of-a-kind or better as a predetermined winning hand combination 276. If a player's hand contains four aces as a premium winning hand composition 278, he or she wins 100% of the second pot 270. The top three hands trigger envy bonuses, and players 240 win, and are awarded from the second pot 270, if any other player 240 receives a straight flush or better. Players can win multiple envy bonuses in a round, but cannot receive an envy bonus for their own hand or the dealer's hand.

FOUR CARD POKER® Progressive is another specific, non-limiting example of a wagering game according to embodiments of the present disclosure. Players 240 make an ante wager as a first wager 252 into the first pot 260 to compete against the dealer and may also make an “aces up” wager as a second wager 254 into the second pot 270 to compete against a pay table. To be eligible for all or part of the progressive jackpot in the second pot 270, players 240 must make the second wager 254 before any cards are dealt. Players 240 receive five cards to make their best four-card hand and the dealer receives six cards to make his best four-card hand, the dealer always qualifies. After reviewing their cards, players 240 may fold or make an additional first wager 252, which can be one to three times their ante. If a player's hand beats or ties the dealer, their play and ante wagers win even money from the first pot 260. If the dealer's hand beats a player's hand, the player 240 loses both wagers. The aces up bonus bet 254 wins when players 240 have a pair of aces or better as a predetermined winning hand combination 276, and wins from the second pot 270 regardless of whether players 240 win or lose to the dealer relative to the first pot 260. If players 240 have a predetermined winning hand combination 276 of a three-of-a-kind or higher, they also win an automatic bonus from the second pot 270 relative to their ante wager. Automatic bonuses from the second pot 270 always win, even when players 240 lose to the dealer relative to the first pot 260. The progressive wager 254 wins when a player's final hand contains a three-of-a-kind or better. The higher the player's hand, the more he wins. The top hand in the game, four aces, is a premium winning hand combination 278 and pays 100% of the progressive jackpot in the second pot 270. Players making the progressive wager 254 also qualify for an envy bonus paid from the second pot 270. If any other player 240 at the table gets a straight flush or better, they win an envy bonus.

FORTUNE PAI GOW® progressive poker is another specific, non-limiting example of a wagering game according to embodiments of the present disclosure. To begin each round, players 240 must make their standard pai gow wager as a first wager 252 into the first pot 260. Players 240 may also make an optional FORTUNE PAI GOW® wager as a first supplemental wager 256 into the second pot 270 and a progressive wager as a second supplemental wager 258 into the second pot 270. Once all players 240 have made their wagers, the dealer follows house procedures for pai gow poker. While reconciling standard pai gow poker wagers 252 from the first pot 260, the dealer also reconciles bonus 254 and progressive wagers 254 from the second pot 270. Players win the fortune wager from the second pot 270 if their hand contains a four-of-a-kind or higher as a predetermined winning hand combination 276. In addition, players 240 who made a minimum fortune wager of $5 are entitled to envy bonuses if someone at the table has a predetermined winning hand combination 276. Only players 240 who made the fortune bonus wager can collect envy bonuses. Players cannot win envy bonuses on their hand or the dealer's hand. For the progressive wager 258, the top hands pay a percentage of the progressive jackpot in the second pot 270, while other hands pay a fixed dollar amount from the second pot 270.

RAISE IT UP® is a six-card poker game that is another specific, non-limiting, example of a wagering game according to embodiments of the present disclosure. Players 240 combine their three cards with three community cards to make their best possible five-card poker hand. Traditional hand rankings apply. The object is to get a pair of 10s or better. Players 240 make equal bets on the ante and blind as first wagers 252 into the first pot 260. Players 240 may also make an optional pair plus bonus bet as a second wager 254 into the second pot 270. Players 240 receive three cards and three community cards are dealt face down on the table. The dealer exposes the community cards one at a time. Players 240 have three chances to make additional first wagers 252 into the first pot 260. The earlier a player 240 bets, the more that player 240 can bet. For example, after seeing three cards, a player 240 may bet 3× the player's ante, after seeing four cards, a player 240 may bet 2× the player's ante, and after seeing five cards, a player may bet 1× the player's ante. A player 240 that does not like his or her hand after five cards, may fold and lose the ante and blind bets that were first wagers 252. A player 240 wins from the first pot 260 with a pair of 10s or better. A player 240 is paid odds out of the second pot 270 for holding a preselected winning hand combination of a pair to four-of-a-kind. This odds payout may include only a portion of the second pot 270. A player 240 wins 100% of the second pot 270 if the player 240 holds a premium winning hand composition 278 of a straight flush. Funds in the second pot 270 continue to grow from round to round until a player 240 achieves a straight flush. The house takes a rake (292 and 294) on all wagers that are won by the players 240, including the first, ante and play wagers 252 and the second, pair plus wager 254. After the second pot 270 is awarded, the house reseeds 296 the second pot 270 with funds from the rake account 290. Because both wagers have a house edge, the pair plus wager 254 is optional. In some embodiments, the house may require the player 240 to contribute to the second pot 270 over the entire jackpot cycle to qualify for a payout from the second pot 270. In other embodiments, players 240 can begin to contribute at any point in the jackpot cycle.

### 2. Gaming Environments

Embodiments of the present disclosure may be practiced in a number of different gaming environments. As non-limiting examples, embodiments, may be practiced on a single-player electronic gaming device, multi-player electronic gaming device, a live table for employing embodiments of the present disclosure, and various electronic gaming platforms that may be accessed by a player using a user device such as a computer, a portable computer, a portable communication device, a personal digital assistant and other suitable devices for communication with the electronic gaming platform. FIGS. 4-8 show non-limiting examples of different gaming environments.

FIG. 4 is an example of a single-player electronic gaming device 300 configured for implementation of embodiments of wagering games according to the present disclosure. The individual electronic gaming device 300 may include an individual player position 314 that includes a player input area 332 for a player to interact with the individual electronic gaming device 300 through various input devices (not shown). The electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, poker chips, and/or live personnel. The action may instead be simulated by a control processor 350 operably coupled to the memory 340 and interacting with and controlling the individual electronic gaming device 300. Although the figure has an outline of a traditional gaming cabinet, gaming device 300 may be implemented in any number of ways, including but not limited to client software downloaded to a portable device, such as a smart phone, tablet, or laptop personal computer. Gaming device 300 may also be a non-portable personal computer (e.g., a desktop or all-in-one computer) or other computing device. In some embodiments, client software is not downloaded but is native to the device, or otherwise delivered with the device when received by a player.

A communication device 360 may be included and operably coupled to the processor 250 such that information related operation of the gaming device 300, information related to the game play, or combinations thereof may be communicated between the gaming device 300 and other devices (not shown) through a suitable communication media, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners (not shown) configured to communicate rules of game play and/or the like, such as along a top portion 378 of the cabinet 376 of the gaming device 300. The individual electronic gaming device 300 may further include additional decorative lights (not shown), and speakers (not shown) for transmitting and/or receiving sounds during game play. Further detail of an example of an individual electronic gaming device (as well as other embodiments of tables and devices) is disclosed in U.S. patent application Ser. No. 13/215,156, filed Aug. 22, 2011, and titled “Methods of Managing Play of Wagering Games and Systems for Managing Play of Wagering Games,” the disclosure of which is incorporated hereby in its entirety by reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format, may be distributed throughout a casino or other gaming site, or may include both grouped and distributed player stations. While some features may be automated through electronic interfaces (e.g., virtual cards, virtual chips, etc.), some features may remain in the physical domain. As such, the game play may be administered by a live dealer, a virtual dealer, or a combination of both.

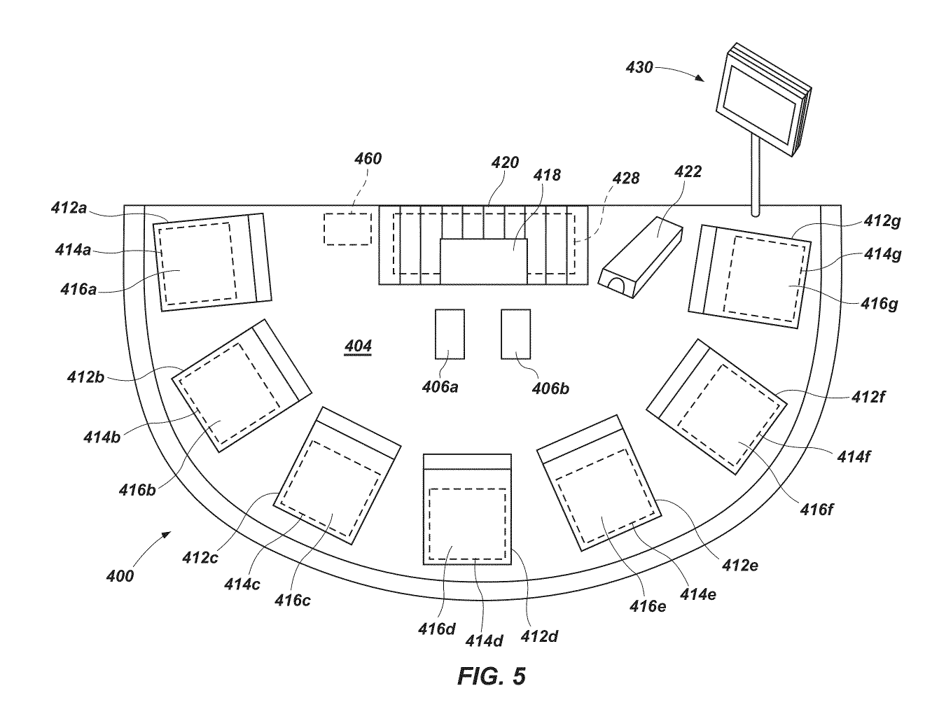

FIG. 5 is an example of a suitable gaming table 400 configured for implementation of embodiments of wagering games according to the present disclosure. The table 400 may include a playing surface 404. The table 400 may include a plurality of player stations 412a through 412g. Each player station 412a through 412g may include a player interface 416a through 416g, which may be used for displaying game information (e.g., game instructions, input options, wager information including virtual chips, game outcomes, etc.). The player interface 416a through 416g may include a display screen in the form of a touch screen, which may be at least substantially flush with the playing surface 404 in some embodiments. Each player interface 416a through 416g may be coupled respectively with its own local game processor 414a through 414g (shown in dashed lines), although in some embodiments, a central game processor 428 (shown in dashed lines) may be employed and communicate directly to player interfaces 416a through 416g. In some embodiments, a combination of individual local game processors 414a through 414g and a central game processor 428 may be employed.

A communication device 460 may be included and operably coupled to one or more of the local processors 414, the central game processor 428, or combinations thereof, such that information related operation of the table 400, information related to the game play, or combinations thereof may be communicated between the table 400 and other devices (not shown) through a suitable communication media, such, as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using virtual chips. For embodiments using physical cards 406a and 406b, the table 400 may further include a card-handling device 422 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 416a through 416g. Common virtual cards may be displayed in a common card area (not shown).

The table 400 may further include a dealer interface 418, which, like the player interfaces 414a through 414g, may include touch screen controls for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to the casino pit.

Further detail of an example of a table and player displays is disclosed in U.S. Patent Application Pub. No. 2010/0016050, filed Jul. 15, 2008, and titled “Split Screen on a Chipless Gaming Table,” the disclosure of which is incorporated hereby in its entirety by reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

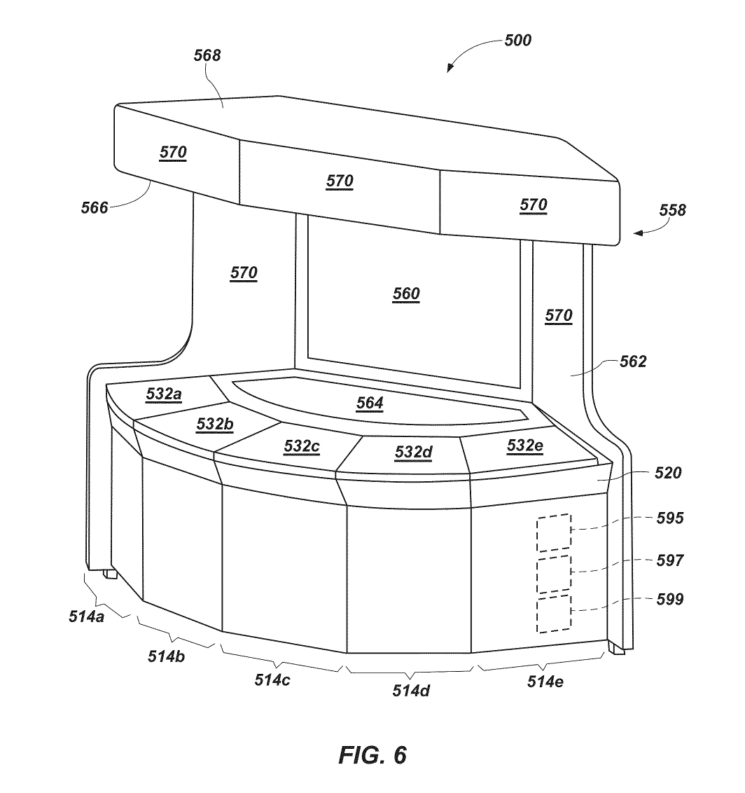

FIG. 6 is an example of a multi-player electronic gaming device 500 configured for implementation of embodiments of wagering games according to the present disclosure. In some embodiments, the multi-player electronic gaming device 500 may include a virtual dealer for some types of games. In other embodiments, there may not be a virtual dealer. The multi-player electronic gaming device 500 may include player positions 514a through 514e that are arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, community cards, and/or player's cards by the virtual dealer on the dealer screen 560 (virtual dealer not shown in FIG. 6).

Each of the player positions 514a through 514e may include a player interface area 532a through 532e, which is configured for wagering and game play interactions with the video device 558 and/or virtual dealer. Accordingly, game play may be accommodated without involving physical playing cards, poker chips, and/or live personnel. The action may instead be simulated by a control processor 597 interacting with and controlling the video device 558. The control processor 597 may be located internally within, or otherwise proximate to, the video device 558. The control processor 597 may be programmed, by known techniques, to implement the rules of game play at the video device 558. As such, the control processor 597 may interact and communicate with display/input interfaces and data entry inputs for each player interface area 532a through 532e of the video device 558. Other embodiments of tables and gaming devices may include a control processor that may be similarly adapted to the specific configuration of its associated device.

A communication device 599 may be included and operably coupled to the control processor 597 such that information related operation of the table 500, information related to the game play, or combinations thereof may be communicated between the table 500 and other devices (not shown) through a suitable communication media, such, as, for example, wired networks, Wi-Fi networks, and cellular communication networks.

The video device 558 may further include banners (not shown) configured to communicate rules of play and/or the like, which may be located along one or more walls 570 of the cabinet 562. The video device 558 may further include additional decorative lights (not shown) and speakers (not shown), which may be located on an underside surface 566, for example, of a generally horizontally depending top 568 of the cabinet 562 of the video device 558 generally extending toward the player positions 514a through 514e.

Further detail of an example of a table and player displays is disclosed in U.S. Patent Application Pub. No. 2005/0164762, filed Jan. 26, 2004, and titled “Automated Multiplayer Game table with Unique Image Feed of Dealer,” the disclosure of which is incorporated hereby in its entirety by reference. Although an embodiment is described showing individual discrete player stations, in some embodiments, the entire playing surface (e.g., player interface areas 532a through 532e, card display 564, etc.) may be an electronic display that is logically partitioned to permit game play from a plurality of players for receiving inputs from, and displaying game information to, the players, the dealer, or both.

Wagering games in accordance with embodiments of the disclosure may be administered over the Internet, or otherwise online, in embodiments using a gaming system employing a client server architecture.

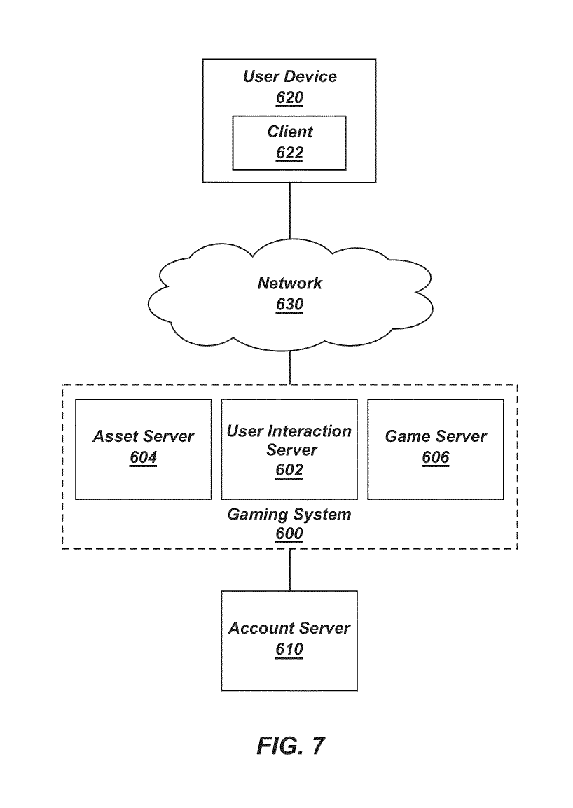

FIG. 7 is a schematic block diagram of a gaming system 600 for implementing wagering games according to the present disclosure. The gaming system 600 enables end users to access proprietary and/or non-proprietary game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not be limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits, being awarded credits as part of a contest or a win event in this or another game (including non-wagering games), being awarded credits as a reward for use of a product, casino or other enterprise, time played in one session, games played, or may be as simple as virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes free credits in exchange for identifying friends who may want to play. In another embodiment, additional credits may be issued after a period of time has elapsed to encourage the player to resume playing the game. The system may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform 608 that establishes a portal for an end user to access a wagering game hosted by a game server 606 through a user interaction server 602. The user device 620 may communicate with a user interaction server 602 of the gaming system 600 using a network 630 (e.g., the Internet). The user interaction server 602 may communicate with the game server 606 and provide game information to the user. In some embodiments, the game server 606 may also be a game engine. In some embodiments, a single user device communicates with a game provided by the game server 606, while other embodiments may include a plurality of user devices 620 configured to communicate and provide end users with access to the same game provided by the game server 606. In addition, a plurality of end users may access a single user interaction server 602, or a plurality of user interaction servers 602, to access game server 606.

The user interaction server 602 may communicate with the user device 620 to enable access to the gaming system 600. The user interaction server 602 may enable a user to create and access a user account and interact with gaming server 606. The user interaction server 602 may enable users to initiate new games, join existing games, and interface with games being played by the user.

The user interaction server 602 may also provide a client 622 for execution on the user device 620 for accessing the gaming system 600. The client 622 provided by the gaming system 600 for execution on the user device 620 can comprise a variety of implementations according to the user device 620 and method of communication with the gaming system 600. In one embodiment, the user device 620 connects to the gaming system 600 using a web browser and the client 622 executes within a browser window or frame of the web browser. In another embodiment, the client 622 is a stand-alone executable on the user device 620.

In one embodiment, the client 622 may comprise a relatively small amount of script (e.g., JAVASCRIPT®), also referred to as a “script driver,” including scripting language that controls an interface of the client 622. The script driver may include simple function calls requesting information from the gaming system 600. In other words, the script driver stored in the client 622 may merely include calls to functions that are externally defined by, and executed by, the gaming system 600. As a result, the client 622 may be characterized as a “thin client.” As that term is used herein, the client 622 may be little more than a script player. The client 622 may simply send requests to the gaming system 600 rather than performing logic itself. The client 622 receives player inputs and the player inputs are passed to gaming system 600 for processing and executing the wagering game. In one embodiment, this includes providing specific graphical display information to client 622, as well as game outcomes.

In other embodiments, the client 622 comprises an executable file rather than a script. In that case, client 622 may do more local processing than does a script driver, such as calculating where to show what game symbols upon receiving a game outcome from game server 606 through user interaction server 602. In one embodiment, it may be that portions of asset server 604 are loaded onto the client 622, and used by the client 622 in processing and updating graphical displays. Due to security and integrity concerns, most embodiments will have the bulk of the processing of the game play performed in the gaming system 600. However, some embodiments may include significant game processing by client 622 when the client and user device 620 are considered trustworthy or when there is reduced concern for security and integrity in the displayed game outcome. In most embodiments, it is expected that some form of data protection, such as end-to-end encryption, will be used when data is transported over network 630. Network 630 may be any network, including, but not limited to, the Internet.

In an embodiment where the client 622 implements further logic and game control methodology beyond a thin client, the client 622 may parse and define player interactions prior to passing the player interactions to the gaming system 600. Likewise, when the client 622 receives a gaming interaction from the gaming system 600, the client 622 may be configured to determine how to modify the display as a result of the gaming interaction. The client 622 may also allow the player to change a perspective or otherwise interact with elements of the display that do not change aspects of the game.

The gaming system 600 may include an asset server 604, which may host various media assets (e.g., audio, video, and image files) that may be sent to the client 622 for presenting the various wagering games to the end user. In other words, in this embodiment the assets presented to the end user may be stored separately from the client 622. In one embodiment, the client 622 requests the assets appropriate for the game played by the user; in other embodiments, especially those using thin clients, just those assets that are needed for a particular display event will be sent by game server 600 when the game server 600 determines they are needed, including as few as one asset. In one example, the client 622 may call a function defined at the user interaction server 602 or asset server 604, which may determine which assets are to be delivered to the client 622 as well as how the assets are to be presented by the client 622 to the end user. Different assets may correspond to the various clients that may have access to the game server 606 or to different games to be played.

The game server 606 is configured to perform game play methods and determine game play outcomes that are provided to the user interaction server 602 to be transmitted to user device 620 for display on the end user's computer. For example, the game server 606 may include game rules for one or more wagering games, such that the game server 606 controls some or all of the game flow for a selected wagering game, as well as determining game outcomes. Game server 606 may include pay tables and other game logic. The game server 606 also performs random number generation for determining random game elements of the wagering game. In one embodiment, the game server 606 is separated from the user interaction server 602 by a firewall or other method of preventing unauthorized access to the game server 606 from the general members of the network 630.

The user device 620 may present a gaming interface to the player and communicate the user interaction to the gaming system 600. The user device 620 may be any electronic system capable of displaying gaming information, receiving user input, and communicating the user input to the gaming system 600. As such, the user device 620 can be a desktop computer, a laptop, a tablet computer, a set-top box, a mobile device, including, but not limited to, smart phones, a kiosk, a terminal, or another computing device. The user device 620 operating the client 622 may comprise an interactive electronic gaming system 300 (see FIG. 5), as described above. The client 622 may be a specialized application or may be executed within a generalized application capable of interpreting instructions from the interactive gaming system 600, such as a web browser.

The client 622 may interface with an end user through a web page, or an application that runs on a device, including, but not limited to, a smartphone, a tablet, or a general computer, or be any other computer program configurable to access the gaming system 600. The client 622 may be illustrated within a casino webpage (or other interface) indicating that the client 622 is embedded into a webpage, which is supported by a web browser executing on the user device 620.

In one embodiment, the gaming system 600 may be operated by different entities. The user device 620 may be operated by a third party, such as a casino or an individual, that links to the gaming system 600, which may be operated, for example, by a wagering game service provider. Therefore, in some embodiments, the user device 620 and client 622 may be operated by a different administrator than the operator of the game server 606. In other words, the user device 620 may be part of a third-party system that does not administer or otherwise control the gaming system 600 or game server 606. In another embodiment, the user interaction server 602 and asset server 604 are provided by a third-party system. For example, a gaming entity (e.g., a casino) may operate the user interaction server 602 or user device 620 to provide its customers access to game content managed by a different entity, which may control game server 606, amongst other functionality. In some embodiments, these functions are operated by the same administrator. For example, a gaming entity (e.g., a casino) may elect to perform each of these functions in-house, such as providing both the access to the user device 620 and the actual game content and providing administration of the gaming system 600.

The gaming system 600 may communicate with one or more external account servers 610, optionally through another firewall (not shown). For example, the gaming system 600 itself may not directly accept wagers or issue payouts. That is, the gaming system 600 may facilitate online casino gaming, but may not be part of a self-contained online casino itself. Instead, the gaming system 600 may facilitate the play of wagering games owned and controlled by a company offering games and gaming products and services, such as SHFL Entertainment, Inc. Another entity (e.g., a casino or any account holder or financial system of record) may operate and maintain its external account servers 610 to accept bets and make payout distributions. The gaming system 600 may communicate with the account servers 610 to verify the existence of funds for wagering, and instruct the account server 610 to execute debits and credits.

In some embodiments, the gaming system 600 may directly accept bets and make payout distributions, such as in the case where an administrator of the gaming system 600 operates as a casino. As discussed above, the gaming system 600 may be integrated within the operations of a casino rather than separating out functionality (e.g., game content, game play, credits, debits, etc.) among different entities. In addition, for play-for-fun wagering games, the gaming system 600 may issue credits, take bets, and manage the balance of the credits according to the game outcomes, but may not permit payout distributions or be linked to an account server 610 that permits payout distributions. Such credits may be issued for free, through purchase, or for other reasons, without the ability for the player to cash out. Such play-for-fun wagering games may be played on platforms that do not permit traditional gambling, such as to comply with jurisdictions that do not permit online gambling.

The gaming system 600 may be configured in many ways, from a fully integrated single system to a distributed server architecture. The asset server 604, user interaction server 602, game server 606, and account server 610 may be configured as a single, integrated system of code modules running on a single server or machine, where each of the servers is functionally implemented on a single machine. In such a case, the functionality described herein may not be implemented as separate code modules. The asset server 604, user interaction server 602, game server 606, and account server 610 may also be implemented as a plurality of independent servers, each using its own code modules running on a separate physical machine, and may further include one or more firewalls between selected servers (depending on security needs). Each server could communicate over some kind of networked connection, potentially as varied as that described for network 630. Further, each single server shown in FIG. 6 may be implemented as a plurality of servers with load balancing and scalability factors built into the embodiment. All such embodiments and variations are fully contemplated.

Additional features may be supported by the game server 606, such as hacking and cheating detection, data storage and archival, metrics generation, messages generation, output formatting for different end user devices, as well as other features and operations. For example, the gaming system 600 may include additional features and configurations as described in U.S. patent application Ser. No. 13/353,194, filed Jan. 18, 2012, and application Ser. No. 13/609,031, filed Sep. 10, 2012 both titled “Network Gaming Architecture, Gaming Systems, and Related Methods,” the disclosure of each is incorporated hereby in its entirety by reference.

The network 630 may enable communications between the user device 620 and the gaming system 600. A network (not shown) may also connect the gaming system 600 and account server 610, and, further, one or more networks (not shown) may interconnect one or more of the other servers shown collectively as game system 600. In one embodiment, the network 630 uses standard communications technologies and/or protocols. Thus, the network 630 can include links using technologies such as Ethernet, 802.11, worldwide interoperability for microwave access (WiMAX), 3G, digital subscriber line (DSL), asynchronous transfer mode (ATM), INFINIBAND®, PCI Express Advanced Switching, etc. Similarly, the networking protocols used on the network 630 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 630 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 630 can include links comprising one or more networks such as the Internet.

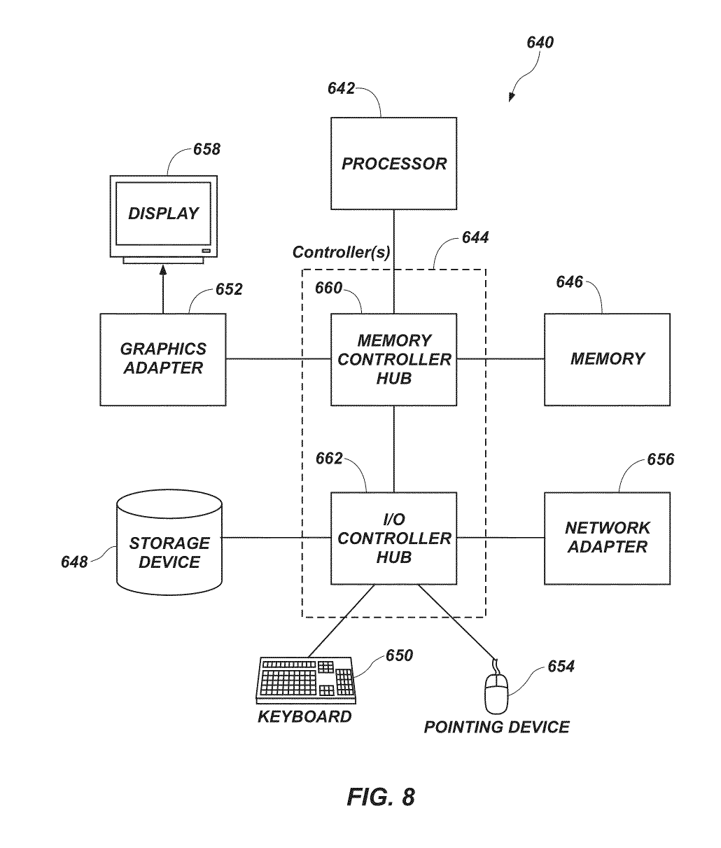

FIG. 8 is a high-level block diagram of a computer system 640 for acting as one or more components in the gaming system 600 (see FIG. 7) according to one or more embodiments. Illustrated are at least one processor 642 coupled to one or more controllers 644, as indicated in dashed lines. Also coupled to the one or more controllers 644 are a memory 646, a storage device 648, a keyboard 650, a graphics adapter 652, a pointing device 654, and a network adapter 656. A display 658 is coupled to the graphics adapter 652. In one embodiment, the functionality of the one or more controllers 644 is provided by a memory controller hub 660 and an I/O controller hub 662. In another embodiment, the memory 646 may be coupled directly to the processor 642 instead of the chipset 644.

The storage device 648 is any non-transitory computer-readable storage medium, such as a hard drive, a compact disk read-only memory (CD-ROM), DVD, or a solid-state memory device (e.g., a flash drive). The memory 646 holds instructions and data used by the processor 642. The pointing device 654 may be a mouse, a track pad, a track ball, or other type of pointing device, and may be used in combination with the keyboard 650 to input data into the computer system 640. The graphics adapter 652 prepares images and other information for the display 658. The network adapter 656 couples the computer system 640 to a local or wide area network.

As is known in the art, a computer system 640 can have different and/or other components than those shown in FIG. 8. In addition, the computer system 640 can lack certain illustrated components. As a non-limiting example, a computer system 640 acting as a server (e.g., 602, 604, 606 and 610 in FIG. 7) may lack a keyboard 650, pointing device 654, graphics adapter 652, and/or display 658. Moreover, the storage device 648 can be local and/or remote from the computer system 640 (such as embodied within a storage area network (SAN)). Moreover, other input devices, such as, for example, touch screens may be included.

The network adapter 656 (may also be referred to herein as a communication device) may include one or more devices for communicating using one or more of the communication media and protocols discussed above with respect to FIG. 7.

In addition, some or all of the components of this general computer system 640 of FIG. 8 may be used as part of the processor and memory discussed above with respect to the systems of FIGS. 4, 5, and 6.

Thus, the computer system 640 shown in FIG. 8 may represent any of the computing systems discussed above with reference to FIGS. 4-7 including the various servers 602, 604, 606 and 610 and user devices 620 discussed with reference to FIG. 7.

The gaming system 600 may comprise several such computer systems 640. The gaming system 600 may include load balancers, firewalls, and various other components for assisting the gaming system 600 to provide services to a variety of user devices.

As is known in the art, the computer system 640 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 648, loaded into the memory 646, and executed by the processor 642.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

While certain illustrative embodiments have been described in connection with the figures, those of ordinary skill in the art will recognize and appreciate that embodiments of the disclosure are not limited to those embodiments explicitly shown and described herein. Rather, many additions, deletions, and modifications to the embodiments described herein may be made without departing from the scope of the invention as hereinafter claimed, including legal equivalents. In addition, features from one disclosed embodiment may be combined with features of another disclosed embodiment while still being encompassed within the scope of embodiments of the invention as contemplated by the inventor.

What is claimed is:

1. A method of administering a wagering game, comprising:
accepting a first wager from a player, the first wager being added to a first pot;
accepting a second wager from the player, the second wager being added to a second pot;
taking a rake for a rake account from at least one of the first wager and the second wager;
dealing cards to each player;
resolving the first wager according to a set of game rules, wherein a winning player wins at least a portion of the first pot at the conclusion of each round of play; and
resolving the second wager according to at least one of:
awarding a fixed odds payout to one or more players holding a predetermined winning hand combination from at least one of the rake account and the second pot; and
awarding a progressive payout to one or more additional players holding a premium winning hand composition from the second pot.

2. The method of claim 1, wherein the rake for the rake account is taken from the first wager.

3. The method of claim 1, wherein the rake for the rake account is taken from the second wager.

4. The method of claim 1, wherein the rake taken from the first wager is less than the rake taken from the second wager.

5. The method of claim 1, further comprising:
after resolving the first wager and awarding the player only the portion of the first pot at the conclusion of each round of play, redistributing a remaining portion of the first pot into the second pot.

6. The method of claim 1, wherein resolving the second wager further comprises:
awarding the fixed odds payout only from the second pot and decrementing the second pot by an amount of the fixed odds payout.

7. The method of claim 1, wherein resolving the second wager further comprises:
awarding the fixed odds payout from only the rake account.

8. The method of claim 1, wherein awarding the progressive payout to the one or more additional players holding the premium winning hand composition further comprises awarding an amount at least as great as a maximum fixed odds payout awardable to the one or more players holding the predetermined winning hand combination.

9. The method of claim 1, wherein awarding the progressive payout to the one or more additional players holding the premium winning hand composition further comprises awarding an entire amount of the second pot, less the rake.

10. The method of claim 1, wherein awarding the progressive payout to the one or more additional players holding the premium winning hand composition further comprises awarding the entire amount of the second pot, less the rake, for the premium winning hand composition selected from the group consisting of a royal flush, a straight flush, and four-of-a-kind.

11. The method of claim 1, wherein taking the rake for the rake account comprises taking the rake greater than a theoretical house advantage for the wagering game.

12. The method of claim 1, wherein taking the rake for the rake account comprises taking the rake less than a historical house advantage for the wagering game.

13. The method of claim 1, wherein taking the rake for the rake account comprises taking the rake of between 3% and 8% from the second wager.

14. The method of claim 1, further comprising seeding the second pot with funds from the rake account.

15. The method of claim 1, wherein the premium winning hand composition comprises a hand that is better than the predetermined winning hand combination according to the set of game rules.

16. The method of claim 1, wherein at least some of the steps are performed by one or more servers.

17. The method of claim 1, wherein at least some of the steps are performed by one or more servers in communication with one or more electronic devices.

18. A gaming system, comprising:
one or more servers for administering a wagering game; and
one or more electronic devices configured for communication with the one or more servers;
wherein the one or more servers and the one or more electronic devices are configured to cooperatively execute the wagering game by performing the acts of:
accepting a first wager from a player, the first wager being added to a first pot;
accepting a second wager from the player, the second wager being added to a second pot;
taking a rake for a rake account from at least one of the first wager and the second wager;
dealing cards to each player;
resolving the first wager according to a set of game rules, wherein a winning player wins at least a portion of the first pot at the conclusion of each round of play; and
resolving the second wager according to at least one of:
awarding a fixed odds payout to one or more players holding a predetermined winning hand combination from at least one of the rake account and the second pot; and
awarding a progressive payout to one or more additional players holding a premium winning hand composition from the second pot.

19. The gaming system of claim 18, wherein the rake for the rake account is taken from the second wager.

20. The gaming system of claim 18, wherein the one or more servers comprise a user interaction server for interfacing with the one or more electronic devices and a game server for administering at least rules of the wagering game.

21. The gaming system of claim 18, wherein the one or more electronic devices comprise a single-player electronic gaming device.

22. The gaming system of claim 18, wherein the one or more electronic devices comprise a multi-player electronic gaming device.

23. The gaming system of claim 18, wherein the one or more electronic devices comprise a portable communication device configured with at least a thin client enabling communication with the one or more servers.

24. A method of administering a wagering game via a computer network, using a combination of one or more servers in communication with one or more electronic devices for interfacing with game players, the method comprising:
accepting a base game wager from one or more players for addition to a base pot;
accepting a first supplemental wager from the one or more players for addition to a non-progressive pot;
accepting a second supplemental wager from the one or more players for addition to a progressive pot;
taking a rake for a rake account from at least one of wagers;
dealing a group of randomized cards to each of the one or more players from whom the base game wager has been accepted;
resolving the base pot according to a predetermined set of game rules,
resolving the non-progressive pot according to the predetermined set of game rules, wherein a payout of the non-progressive pot is credited to each player from whom the first supplemental wager has been accepted and who holds a highest ranking hand at the conclusion of a round of play according to the predetermined set of game rules; and
resolving the progressive pot by crediting a payout to eligible players from whom the second supplemental wager has been accepted according to at least one of:
odds payouts from the rake account or from the progressive pot to the eligible players holding one of a predetermined plurality of winning hand combinations; and
an entire amount in the progressive pot to eligible players holding a premium winning hand combination.

25. The method of claim 24, further comprising taking a rake for the rake account from the base game wager.

26. The method of claim 24, further comprising taking a rake for the rake account from the first supplemental wager.

27. The method of claim 24, wherein crediting the payout to each player holding one of a predetermined plurality of winning hand combinations comprises crediting a percentage of the progressive pot to each such player.

28. The method of claim 24, wherein taking the rake for the rake account comprises taking the rake greater than a theoretical house advantage for the wagering game.

29. The method of claim 24, wherein taking the rake for the rake account comprises taking the rake of between 3% and 8% from at least one of wagers.

30. The method of claim 24, further comprising seeding the progressive pot with at least some funds from the rake.

31. A method of administering a wagering game, comprising:
accepting a base wager set of playing chips from a player;
adding the base wager set of playing chips to a base pot of playing chips;
accepting a supplemental non-progressive wager set of playing chips from the player;
adding the supplemental non-progressive wager set of playing chips to a non-progressive pot of playing chips;
accepting a supplemental progressive wager set of playing chips from the player;
adding the supplemental progressive wager set of playing chips to a progressive pot of playing chips;
taking a rake set of playing chips from at least one of the base wager set of playing chips, the supplemental non-progressive wager set of playing chips, the supplemental progressive wager set of playing chips, the base pot of playing chips, the non-progressive pot of playing chips, and the progressive pot of playing chips;
dealing cards to each player;
awarding at least a portion of the base pot of playing chips to at least one first winning player according to a set of game rules at the conclusion of each round of play;
awarding at least a portion of the non-progressive pot of playing chips to at least one second winning player holding a predetermined winning hand combination; and
awarding at least a portion of the progressive pot of playing chips to at least one third winning player holding a premium winning hand combination.
